(19) United States
(12) Patent Application Publication
(10) Pub. No.: US 2017/0248109 A1
(43) Pub. Date: Aug. 31, 2017

(54) INJECTOR HAVING IN-BUILT IGNITION SYSTEM

(71) Applicant: Imagineering, Inc., Kobe-shi, Hyogo (JP)

(72) Inventors: Yuji Ikeda, Hyogo (JP); Hiroki Katano, Hyogo (JP)

(73) Assignee: Imagineering, Inc., Kobe-shi, Hyogo (JP)

(21) Appl. No.: 15/314,885

(22) PCT Filed: May 29, 2015
(86) PCT No.: PCT/JP2015/065674

§ 371 Date: May 16, 2017

(30) Foreign Application Priority Data
May 29, 2014 (JP) 2014-111754

(51) Int. Cl. F02M 57/06; F02P 5/00; H05H 1/52; F02P 13/00; F02P 23/04

(52) U.S. Cl. CPC F02M 57/06; F02P 13/00; F02P 23/04; H05H 1/52; F02P 5/00

(57) ABSTRACT

A small-size injector having a built-in ignition device which can surely inject fuel and ignite the fuel with low electric power by the ignition device with a simple configuration is provided. The injector comprises a fuel injecting device 2 provided with a fuel injecting port 20 configured to inject the fuel, an ignition device 3 configured to ignite the injected fuel, and a casing 10 inside housing therein the fuel injecting device 2 and the ignition device 3 together. The ignition device 3 is constituted of a plasma generator 3 which integrally comprises a booster 5 having a resonation structure capacity-coupled with an electromagnetic wave oscillator MW configured to oscillate an electromagnetic wave, and a discharger 6 configured to cause a discharge of a high voltage generated by the booster 5.

### TECHNICAL FIELD

The present invention relates to an injector having a built-in ignition device.

### PRIOR ART

Various injectors incorporated with ignition plug are suggested as injectors incorporating ignition device. These are expected for use to direct-inject-type-engines with regard to diesel engines, gas engines, and gasoline engines. Injectors incorporating ignition device are classified broadly into those having coaxial structure in which the axial center of injector (fuel injecting device) is aligned with the axial center of the central electrode of ignition plug used as ignition device, and those of accommodating fuel injecting device and ignition device within a casing by aligning in parallel. The coaxial structure type is disclosed in, for example, Japanese unexamined patent application publication No. H07-71343, and Japanese unexamined patent application publication No. H07-19142. With regard to the injector incorporating the ignition device, the central electrode of the ignition plug used as the ignition device is constituted into hollow type with step portion formed with sheet member at the tip end, and constituted such that needle for opening and closing the sheet member by the operation of actuator is inserted into the central electrode. Thereby, the attachment to internal combustion engine can easily be performed.

The structure of aligning the fuel injecting device and the ignition device in parallel is disclosed in, for example, Japanese unexamined patent application publication No. 2005-511966 and Japanese unexamined patent application publication No. 2008-255837. The injector incorporating the ignition device is configured to arrange the fuel injecting device and the ignition plug used as the ignition device such that the fuel injecting device and the ignition plug are provided at a predetermined interval in parallel within the cylindrical casing, and formed such that the normal fuel injecting device and ignition plug can be used. Therefore, the fuel injecting device and the ignition plug are not required for being designed newly.

### PRIOR ART DOCUMENTS

### Patent Document

Patent Document 1: Japanese unexamined patent application publication No. H07-71343
Patent Document 2: Japanese unexamined patent application publication No. H07-19142
Patent Document 3: Japanese unexamined patent application publication No. 2005-511966
Patent Document 4: Japanese unexamined patent application publication No. 2008-255837

### SUMMARY OF INVENTION

### Problems to be Solved

However, in the injector incorporating the ignition device disclosed in Japanese unexamined patent application publication No. H07-71343 and Japanese unexamined patent application publication No. H07-19142, there is a problem that the actuator for operating needle of the injection nozzle such as electromagnetic coil and piezo element, may be malfunctioned or damaged caused of influence of tens of thousands of volts of high voltage from the ignition coil flown into the central electrode of the ignition plug used as the ignition device. Further, since the injector incorporating the ignition device disclosed in Japanese unexamined patent application publications No. 2005-511966 and No. 2008-255837, is configured to arrange the fuel injecting device and the ignition plug used as the ignition device within one casing and the normal ignition plug is used, there was a problem that the outer diameter length of the ignition plug has limitation for reducing, then the outer diameter of the casing becomes large entirely, and it is difficult to secure space for attaching to the internal combustion engine.

The present invention is developed in view of the above problems. An objective is to provide an injector having a built-in ignition device which can prevent an actuator of a fuel injecting device from malfunctioning without using tens of thousands of volts of high voltage from an ignition coil for the ignition device, reduce an outer diameter length of the ignition device, and achieve miniaturization of the device entirely, even in a coaxial structure in which an axial center of a fuel injecting device and an axial center of an ignition device are coincide with.

### Means to Solve the Problems

An invention for solving the problems is an injector having a built-in ignition device, and the injector comprises an ignition device comprising a booster having a resonation structure capacity-coupled with an electromagnetic wave oscillator configured to oscillate an electromagnetic wave; a ground electrode; and a discharge electrode, which are integrally provided to constitute a plasma generator configured to enhance a potential difference between the ground electrode and the discharge electrode by the booster, thereby generating a discharge, a fuel injecting device comprising a valve seat and a nozzle needle having a valve body and configured to move the valve body of the nozzle needle toward or away from the valve seat to control a fuel injection, and the ignition device has a cylindrical member that constitutes an outer circumferential part of the ignition device, and the nozzle needle has a hollow cylindrical shape which is slidably fitted with an outer surface of the cylindrical member of the ignition device.

The injector having the built-in ignition device comprises the plasma generator which is the ignition device integrally comprising the booster having the resonation structure capacity-coupled with the electromagnetic wave oscillator for oscillating the electromagnetic wave, the ground electrode, and the discharge electrode. Only a discharger can become a high electromagnetic field, and an insulating structure in a route path to the discharger can be simplified. Thereby, significant reduction of the diameter can be achieved compared to the generally used ignition plug. It is configured that the ignition device (plasma generator) with a small diameter has the cylindrical member that constitutes an outer circumferential part of the ignition device, and the nozzle needle has the hollow cylindrical shape which is slidably fitted with the outer surface of the cylindrical member of the ignition device, and therefore, the device size can be compacted as a whole. Moreover, the booster can be formed of a plurality of resonation circuits, a supplied electromagnetic wave is sufficiently boosted, the potential difference between the ground electrode and the discharge electrode is enhanced (the high voltage is generated) in order to occur discharge, and the fuel injected from the fuel injecting device can surely be ignited. Moreover, the booster (resonator) including the resonation structure can be downsized by increasing the electromagnetic wave frequency (for example, 2.45 GHz), and this point also contributes to the miniaturization of the plasma generator.

A second invention for solving the problems is an injector having a built-in ignition device, and the injector comprises an ignition device comprising a booster having a resonation structure capacity-coupled with an electromagnetic wave oscillator configured to oscillate an electromagnetic wave; a ground electrode; and a discharge electrode, which are integrally provided to constitute a plasma generator configured to enhance a potential difference between the ground electrode and the discharge electrode by the booster, thereby generating a discharge, a fuel injecting device comprising a valve seat and a nozzle needle having a valve body and configured to move the valve body of the nozzle needle toward or away from the valve seat to control a fuel injection, and the valve body of the nozzle needle is integrally formed on an outer surface of an outer circumferential part of the ignition device.

The injector having the built-in ignition device of the present invention is configured such that the valve body of the nozzle needle that becomes a main part of the fuel injecting device is integrally formed on the outer surface of the outer circumferential part of the ignition device. Thereby, leakage of fuel in the fuel sump room chamber and the pressure chamber to outside can be suppressed.

Moreover, the fuel injecting device has a plurality of injecting ports opened at a predetermined interval in a circumferential direction, and an interval between the discharge electrode and the ground electrode is adjusted so as to cause a discharge between the adjacent injecting ports. By adjusting the interval between the discharge electrode and the ground electrode in this manner, fuel never contacts with the discharge electrode directly, the discharger causes a discharge at a mixing region of fuel with air, and a suitable ignition can be achieved.

In this case, the discharge electrode has a circumferential portion formed in a continuous convex concave shape, and thereby an adjustment can be performed such that discharge easily occurs between the adjacent injecting ports.

### Effect of Invention

An injector having a built-in ignition device of the present invention is provided, which can prevent an actuator of a fuel injecting device from malfimctioning, reduce an outer diameter length of the ignition device, and achieve miniaturization of the device entirely, even in a coaxial structure in which an axial center of the fuel injecting device and an axial center of the ignition device are coincide with.

### SIMPLE EXPLANATION OF FIGURES

FIG. 1 illustrates a front view of a partial cross section showing an injector having a built-in ignition device of a first embodiment, (a) is a front view of a cross section showing a fuel cutoff state, and (b) is a cross-sectional front view showing a fuel injecting state.

FIG. 2 is a cross sectional front view showing a plasma generator used as a plasma device of the injector having the built-in ignition device.

FIG. 3 illustrates a bottom view showing a relation between a fuel injecting part of the injector having the built-in ignition device and a discharger, (a) is a schematic view illustrating a fuel region, a discharge region, and (b) is a schematic view illustrating a discharge gap.

FIG. 4 illustrates embodiments in which a discharge electrode of the plasma generator is different from each other and (a) to (c) are examples of reducing the size of a discharge gap partially, (a) is continuous convex concave shape in the outer circumferential surface, (b) is a teardrop shape seen from a front viewpoint, (c) is ellipse shape.

FIG. 5 illustrates an injector having a built-in ignition device of a modification example of the first embodiment, (a) is a front view of a cross section, and (b) is a plan view of a casing.

FIG. 6 illustrates a front view of a partial cross section showing an injector having a built-in ignition device of a second embodiment, (a) is a cross sectional front view showing a fuel cutoff state, and (b) is a cross sectional front view showing a fuel injecting state.

FIG. 7 is an equivalent circuit of a booster of the plasma generator.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

### First Embodiment

### Injector Having Built-in Ignition Device

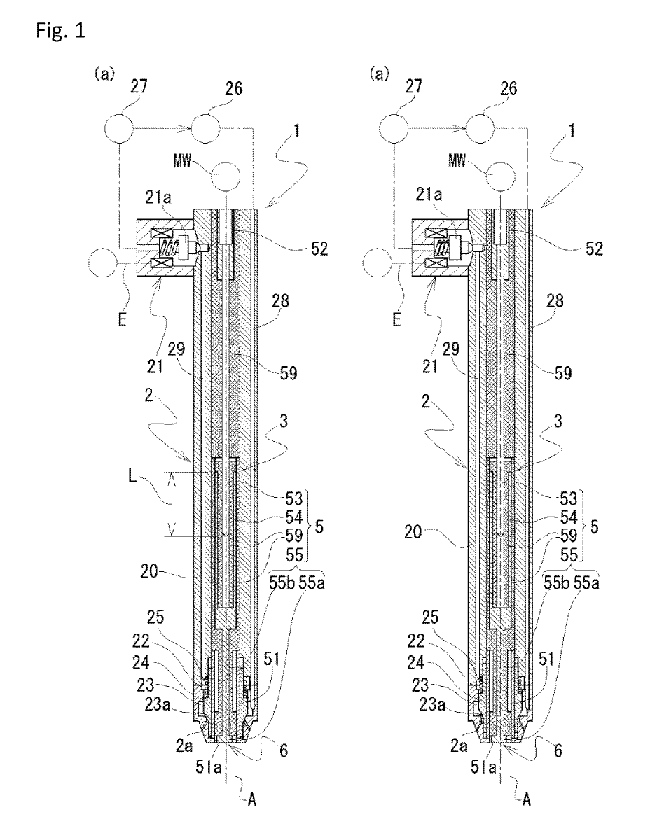

The present first embodiment is an injector 1 having a built-in ignition device regarding the present invention. As illustrated in FIG. 1, the injector 1 has a configuration in which an axial center of an fuel injecting device 2 and an axial center of a plasma generator 3 as an ignition device are respectively coincide with. With regard to an axial center A of the fuel injecting device 2 and the plasma generator 3, the axial center A indicates the axial center of a nozzle needle 24 having a hollow cylindrical shape regarding the fuel injecting device 2, and it indicates the axial center of central electrode 53, 55 having a shaft shape regarding the plasma generator 3.

The injector 1 having the built-in ignition device includes the plasma generator 3 used as the ignition device, and the fuel injecting device 2 comprising a valve seat (orifis) 23a and a nozzle needle 24 having a valve body and configured to move the valve body of the nozzle needle toward or away from the valve seat (orifis) 23a to control a fuel injection. The axial centers of the fuel injecting device 2 and the plasma generator 3 become coincide with by arranging the nozzle needle 24 having a hollow cylindrical shape slidably fitting with the outer surface of a cylindrical member of the ignition device 3. Fixing means of the injector 1 having the built-in ignition device is not especially limited, a sealing member is interposed between, male screw part engraved on the outer surface of the injector 1 having the built-in ignition device can be engaged with female screw part engraved in a mounting port so as to fix, or the injector 1 having the built-in ignition device can be pressured and fixed from upwards by the fixing means.

Fuel Injecting Device

The fuel injecting device 2 having a fuel injection function for the injector 1 having the built-in ignition device, as main parts, comprises a fuel injecting port 2a configured to inject fuel, the orifis (valve seat) 23a connected to the fuel injecting port 2a, and the nozzle needle 24 including a valve body for opening and closing the orifis 23. The nozzle needle 24 has a hollow cylindrical shape, and is arranged so as to be slidably fitted with the outer surface of the cylindrical member that constitutes an outer circumferential part of the plasma generator 3 as below mentioned. From a viewpoint of preventing high pressure fuel from leaking inside, it is preferably formed such that a space gap between the inner surface of the nozzle needle 24 and the outer surface of the cylindrical member that constitutes the outer circumference part of the plasma generator 3 becomes zero as much as possible. The nozzle needle 24 is configured to move the valve body toward or away from the orifis 23a by the operation of the actuator 21. As the actuator 21, as illustrated, an electromagnetic coil actuator can be used, but piezo element (piezo element actuator) which can control the fuel injection period and the injection timing (multi-stage injection) in nanoseconds is preferably used as the actuator 21.

Specifically, high pressure fuel is introduced from a fuel supply flow path 28 into a pressure chamber 25 and a fuel sump room chamber 23 connected to the orifis 23a formed in a main body part 20 (which may function as a case 51 of the plasma generator 3 as below mentioned). In a state where the fuel is not injected (referring to FIG. 1(a)), a pressure-receiving surface of a nozzle needle 21 on which the pressure from the high pressure fuel acts is larger in the pressure chamber 25 than the fuel sump room chamber 23, and the nozzle needle 21 is biased to the side of orifis 23a via biasing means 22 (for example, spring). Therefore, the fuel does not flow into the injection port 2a via the orifis 23a from the fuel sump room chamber 23. The actuator 21 is operated based on injection instructions (for example, current E for driving the fuel injecting valve supplied to the electromagnetic coil actuator) from the control means (for example, ECU), a valve 21a for maintaining airtightness in the pressure chamber 25 is pulled up, the high pressure fuel inside the pressure chamber 25 is released to a tank 27 via an operated flow path 29, and the nozzle needle 24 is separated from the orifis 23a by reducing the pressure in the pressure chamber 25 (referring to the FIG. 1(b)). Thereby, the high pressure fuel (gasoline, diesel fuel, gas fuel and etc.) in the fuel sump room chamber 23 passes through the orifis 23a, and is injected from the fuel injecting port 2a. The symbol numeral 27 indicates a fuel tank, and the symbol numeral 26 indicates a fuel pump including regulator. The high pressure fuel released out of the injector 1 having the built-in ignition device from the pressure chamber 25 is preferably configured to circulate into the fuel tank 27. However, when the gas is used as the high pressure fuel, it can be configured to be supplied to an intake manifold (suction passage) and mixed with intake air.

A plurality of fuel injecting ports 2a are preferably opened at a predetermined interval in a circumferential direction. Specifically, a plurality of fuel injecting ports (eight positions in figure example) are to be opened coaxially with the axial center A.

Plasma Generator

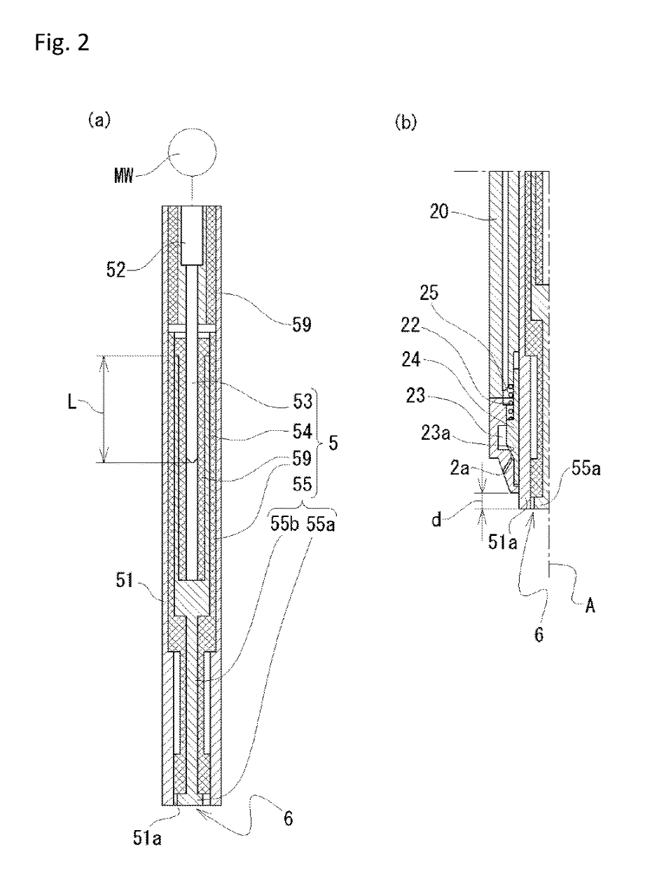

The plasma generator 3 integrally comprises a boosting means 5 (a booster) which has a resonation structure capacity-coupled with an electromagnetic wave oscillator MW for oscillating an electromagnetic wave, a ground electrode (tip end part 51a of a case 51), and a discharge electrode 55a. The boosting means 5 enhances a potential difference between the ground electrode (tip end part 51a) and the discharge electrode 55a (high voltage is generated) in order to generate the discharge. Note that, the hatching part in the cross-sectional view indicates metal, and the cross hatching part indicates an insulator. Furthermore, FIG. 2 indicates the plasma generator 3 around which a case 51 covers entirely. In the plasma generator 3 of the injector 1 having the built-in ignition device as illustrated in FIG. 1, the case 51 is formed only on the part which covers the vicinity of the central electrode 55 of an output part and an insulator 59 such that the inner surface of the nozzle needle 24 is in sliding contact with, and the other portion of the insulator 59 is covered by the main body part 20. Then, in the plasma generator 3 around which the case 51 covers entirely, as illustrated in FIG. 2 (b), movement in a direction parallel to the axial center A with regard to the main body part 20 can be performed. An example of being moved downwards only by distance d from a lower end surface of the main body part 20, is illustrated in FIG. 2(b). By sliding the plasma generator 3, and adopting a structure in which a distance between the fuel injecting port 2a and the discharger 6 can be changed, adjustment for suitable ignition of the injected fuel can be performed.

The boosting means 5 includes a central electrode 53 which is an input part, the central electrode 55 which is an output part, an electrode 54 which is a combining part, and an insulator 59. The central electrode 53, the central electrode 55, the electrode 54, and the insulator 59 are together accommodated coaxially inside the case 51, but not limited to this. The insulator 59 is divided into the following structures, insulator 59a, insulator 59b, and insulator 59c in the present embodiment. The structure is not limited to this. The insulator 59a insulates an input terminal 52 and a part of the central electrode 53 of the input part from the case 51. The insulator 59b insulates the central electrode 53 of the input part from the electrode 54 of the combining part, and both the electrodes are capacity-coupled with. The insulator 59c insulates the electrode 54 of the combining part from the case 51, a shaft part 55b of the central electrode 55 which is an output part is insulated from the case 51 so as to form a resonance space. Further, the insulator 59c has a function of performing positioning of the discharge electrode 55a.

The discharge electrode 55a of the central electrode 55 which is an output part is electrically connected with the electrode 54 of the combining part via the shaft part 55b. The central electrode 53 of the input part is electrically connected to the electromagnetic wave oscillator MW via the input terminal 52.

The electrode 54 of the combining part has a cylindrical shape with a bottom. A coupling capacity C1 is determined by the inner diameter of the cylindrical part of the electrode 54, the outer diameter of the central electrode 53, and the coupling degree (distance L) between tip end part of the central electrode 53 and the cylindrical part of the electrode 54. In order to adjust the coupling capacity C1, the central electrode 53 can be arranged movably toward the axial center direction, for example, so as to be adjustable by screw. Furthermore, adjustment of the coupling capacity C1 can easily be performed by cutting an opening end part of the electrode 54 obliquely.

The resonance capacity C2 is grounding capacitance (stray capacitance) by capacitor C₂ formed of the electrode 54 of the combining part and the case 51. The resonance capacity C2 is determined by the cylindrical length of the electrode 54, the outer diameter, the inner diameter of the case 51 (the inner diameter of part which covers the electrode 54), space gap between the electrode 54 and the case 51 (space gap of part which covers the electrode 54), and dielectric constant of the insulator 59c. The detailed length of the capacitor C₂ part is designed so as to resonate in accordance with the frequency of the electromagnetic wave (microwave) oscillated from the electromagnetic wave oscillator MW.

The resonance capacity C3 is capacitance at the discharge side (stray capacitance) by capacitor C₃ formed of the part covering the central electrode 55 which is an output part and the central electrode 55 of the case 51. The central electrode 55 of the output part, as described as above, includes the shaft part 55b extended from center of the bottom plate of the electrode 54 of the combining part and the discharge electrode 55a formed at tip end of the shaft part 55b. The discharge electrode 55a has a larger diameter than the shaft part 55b. The resonance capacity C3 is determined by the length of the discharge electrode 55a and the length of the shaft part 55b, the outer diameters, the inner diameter of the case 51 (inner diameter of part which covers the central electrode 55), space gap between the central electrode 55 and the case 51 (space gap of the part in which the tip end part 51a of the case 51 covers the central electrode 55), and the thickness and the dielectric constant of the insulator 59c covering the shaft part 55b. Specifically, area of an annular part formed by the space gap between the outer circumferential surface of the discharge electrode 55a and the inner circumferential surface of the tip end part 51a, and distance between the outer circumferential surface of the discharge electrode 55a and the inner circumferential surface of the tip end part 51a are important factors for determining the resonance frequency, and therefore, they are more-accurately calculated.

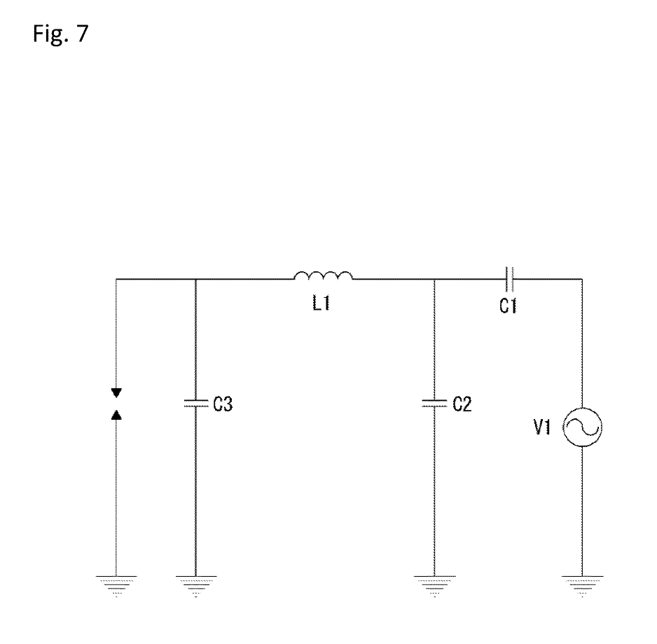

In the resonance structure forming the boosting means 5, with regard to the resonance capacity C2, C3 of capacitor C₂, C₃ (referring to equivalent circuit illustrated in FIG. 7) formed between the electrodes (central electrode 53 of the input part and electrode 54 of the combining part) and the casing 51, each length is adjusted such that C2 sufficiently becomes larger than C3 (C2>>C3). By adopting such a configuration, the electromagnetic wave is sufficiently boosted to become high voltage, and discharge (breakdown) can be performed.

By adopting such a configuration for the boosting means 5, the outer diameter of the plasma generator 3 as the ignition device can be about 5 mm, and the injector 1 having the built-in ignition device can be downsized as a whole.

The discharge electrode 55a is preferably arranged movably in the axial direction toward the shaft part 55b, but the discharge electrode 55a may be formed integrally with the shaft part 55b. Moreover, the resonance capacity C3 can also be adjusted by preparing a plural types of discharge electrodes 55a in which an outer diameter of each discharge electrode differs from each other. Specifically, the male screw part is formed on the tip end of the shaft part 55b, and the female screw part corresponding to the male screw part of the shaft part 55b is formed on the bottom surface of the discharge electrode 55a. Moreover, the circumferential surface of the discharge electrode 55a may be configured to be wave shape, the discharge electrode 55a may be configured to be spherical shape, hemispherical shape, or rotational ellipse body shape, such that the distance between the discharge electrode 55a and the inner surface of the tip end part 51a of the case 51 is different in some points in a direction intersecting with the axial direction. The discharge electrode 55a and the inner surface (ground electrode) of the tip end part 51a of the case 51 constitute the discharger 6, and discharge is generated at the gap between the discharge electrode 55a and the inner surface (ground electrode) of the tip end part 51a of the case 51.

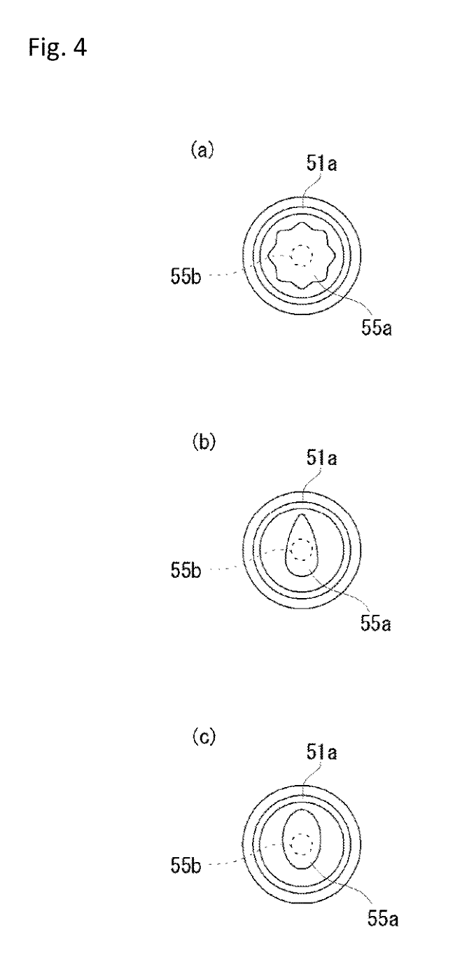

The discharge electrode 55a forming the discharger 6 may be teardrop shape or elliptic shape as illustrated in FIGS. 4(b) and 4(c), in order to surely perform the discharge, and mounted toward the shaft part 55b with eccentricity. Thereby, the discharge is surely caused between the inner circumference surface (grounding electrode) of the tip end part 51a of the case 51 and the sharp head part of the discharge electrode 55a. Note that, even in a case of adopting such a shape, the area of the annular part formed by space gap between the outer circumference surface of the discharge electrode 55a and the inner circumference surface of the tip end part 51a and the distance between the outer circumference surface of the discharge electrode 55a and the inner circumference surface of the tip end part 51a are important factors for determining the resonance frequency, and therefore, the area of the annular part and the distance between the outer circumference surface of the discharge electrode 55a and the inner circumference surface of the tip end part 51a are more-accurately calculated.

By shortening the discharge gap partially in this manner, the discharge can be performed with low power under high atmosphere pressure circumstance. According to experiments by inventors, in a case where the discharge electrode 55a has a cylindrical shape and coaxially with the case 51, the discharge was occurred at 840W under 8 atm, and was not occurred even at 1 kW under 9 atm. On the other hand, in a case where the discharge gap is partially shortened, it can be confirmed that the discharge is occurred at 500W under 15 atm. Moreover, if the output is 1.6 kW, it can be confirmed that the discharge occurs under the 40 atm or the above.

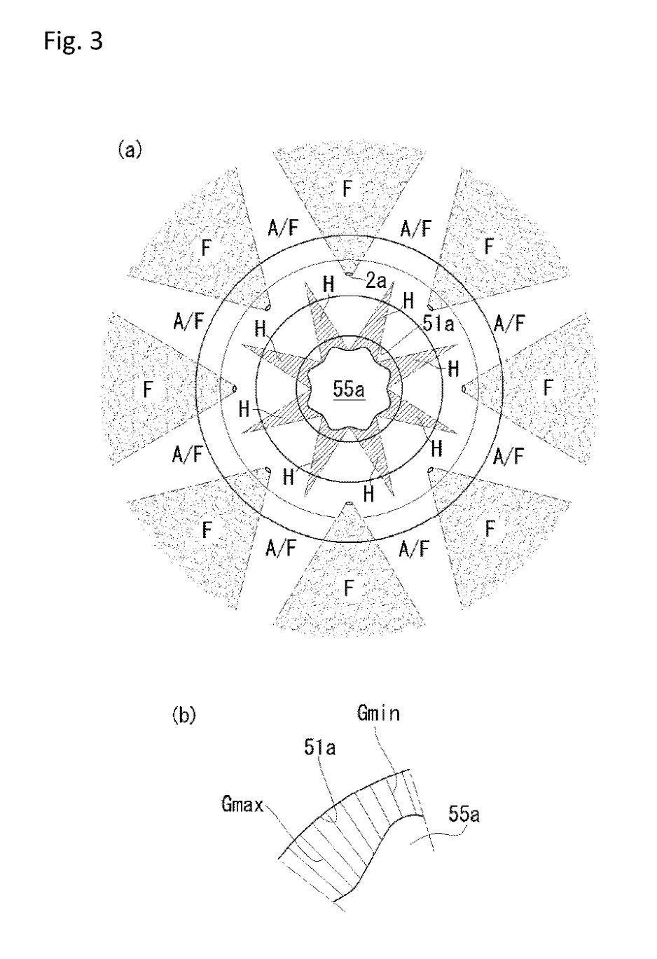

Moreover, the discharge electrode 55a can have a circumferential portion formed in a continuous convex concave shape as illustrated in FIG. 3 and FIG. 4(a). The number of the convex portion and the concave portion is respectively determined in accordance with the fuel injecting ports 2a. In the present embodiment, eight convex-concave portions are formed. The distance between the circumference surface of a pair of convex concave shape and the inner circumference surface of the tip end part 51a of the case 51, i.e. distance of the discharge gap, becomes a max value Gmax at the concave portion, and a minimum value Gmin at the convex portion as illustrated in FIG. 3(b). The discharge is easy to occur in the vicinity of the portion in which the discharge gap becomes the minimum value Gmin. It is adjusted such that the convex portion on the circumference surface of the discharge electrode 55a is positioned between the adjacent fuel injecting ports of the fuel injecting device, and thereby, a space gap between the discharge electrode 55a and the ground electrode (the inner circumference surface of the tip end part 51a of the case 51) is determined. Then, a discharge region H is adjusted such that the discharge is caused between the adjacent fuel injecting ports 2a. By adjusting as above, the region H is not overlapped with the fuel injection region F, the discharge region H becomes A/F position which includes both the fuel injection region F and air existence region A, in other words, a mixing region of fuel with air, and a suitable ignition can be achieved.

Operation of Ignition Device

The plasma generating operation of the plasma generator 3 as the ignition device is explained. In the plasma generating operation, the plasma is generated in the vicinity of the discharger 6 caused by the discharge from the discharger 6, and the fuel injected from the fuel injecting valve 2 is ignited.

Specifically, the plasma generating operation is firstly to output an electromagnetic wave oscillation signal with a predetermined frequency f by a control unit (not illustrated). The signal is synchronized with the fuel injecting signal transmitted to the fuel injecting device 2 (i.e., timing of which a predetermined period has passed after the transmission of the fuel injecting signal), and then the signal is emitted. When the electromagnetic wave oscillator MW receives such an electromagnetic wave oscillation signal, the electromagnetic wave oscillator MW for receiving power supply from an electromagnetic wave source (not illustrated) outputs an electromagnetic wave pulse with the frequency f at a predetermined duty ratio for a predetermined set time. The electromagnetic wave pulse outputted from the electromagnetic wave oscillator MW becomes high voltage by the boosting means 5 of the plasma generator 3 of which the resonance frequency is f. The system of becoming the high voltage, as described as above, can be achieved since it is configured that C2 is sufficiently larger than C3, with regard to the resonance capacitance (stray capacitance) C2, C3, and the stray capacitance C3 between the central electrode 55 and the case 51 and the stray capacitance C2 between the electrode 54 of the combining part and the case 51 are to resonate with a coil (corresponding to the shaft part 55b, specifically, L1 of equivalent circuit). Then, boosted-electromagnetic-wave causes the discharge between the discharge electrode 55a and the inner surface (ground electrode) of the tip end part 51a of the case 51 so as to generate spark. By the spark, the electron is released from gaseous molecule generated in the vicinity of the discharger 6 of the plasma generator 3, the plasma is generated, and the fuel is ignited. Note that, the electromagnetic wave from the electromagnetic wave oscillator MW may be continuous wave (CW).

Effect of First Embodiment

The injector 1 having the built-in ignition device of the first embodiment uses as the ignition device the plasma generator 3 having a small diameter which can boost the electromagnetic wave and perform discharge. Therefore, malfunction or damage of the actuator 21 caused of influence of high voltage from the ignition coil can be prevented. Since the plasma generator 3 positioned inside the fuel injecting device 2 has a small diameter, the outer diameter length of the device as a whole can significantly be reduced. Further, heat released from the fuel injecting device 2 and the plasma generator 3 is cooled down by fuel which flows through the fuel supply flow path 28 and the operated flow path 29 of the main body part 20.

First Modification of the First Embodiment

In a first modification of the first embodiment, an electromagnetic wave irradiation antenna 4 is provided, and the antenna is configured to supply an electromagnetic wave into the discharge plasma from the plasma generator 3 as the ignition device, and maintain and expand the plasma. The configuration other than the arrangement of the electromagnetic wave irradiation antenna 4 is similar with the first embodiment, and the explanation is omitted.

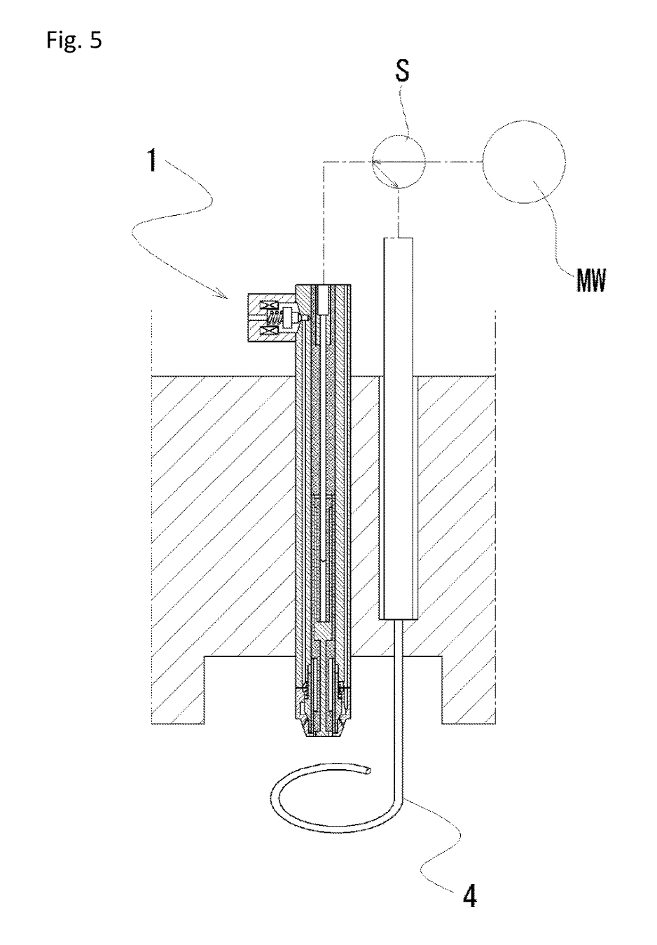

The electromagnetic wave irradiation antenna 4 can be mounted to, for example, the cylinder head of the internal combustion engine by making a mounting port thereon, separately from the main body part 20, as illustrated in FIG. 5. However, an antenna 4 which is extended of an inner conductor of a coaxial cable can structurally be used, and therefore, by adopting the coaxial cable having a small diameter, the antenna can be mounted to the main body part 20 by inserting the same cable. In this case, antennas 4 can also be mounted to multiple positions.

The electromagnetic wave supplied into the electromagnetic wave irradiation antenna 4 is supplied with the reflection wave of the electromagnetic wave supplied into the plasma generator 3 via circulator S. The circulator includes three or more input-output-terminals, and it is a circuit in which the input-output-direction of each terminal is determined. In the present embodiment, the wire connection is performed, in which the electromagnetic wave from the electromagnetic wave oscillator MW flows into the plasma generator 3, and the reflection wave from the plasma generator 3 flows into the electromagnetic wave irradiation antenna 4. By using the circulator S and using the reflection wave of the plasma generator 3 in this manner, there is no need for preparing an additional electromagnetic wave oscillator for the electromagnetic wave irradiation antenna 4.

The length of the electromagnetic wave irradiation antenna 4 is preferably set so as to be integer multiple of λ/4 when the frequency of the electromagnetic wave irradiated is λ.

By irradiating the reflection wave from the plasma generator 3 via circulator S, plasma generated at the local plasma generation region can be maintained and expanded, and the fuel injected from the fuel injecting device 2 can stably be ignited.

Further, an electromagnetic wave oscillator for the electromagnetic wave irradiation antenna 4 is prepared, and the electromagnetic wave (microwave) from the electromagnetic wave irradiation antenna 4 may be irradiated as continuous wave (CW) or pulse wave.

### Second Embodiment—Injector Having Built-in Ignition Device

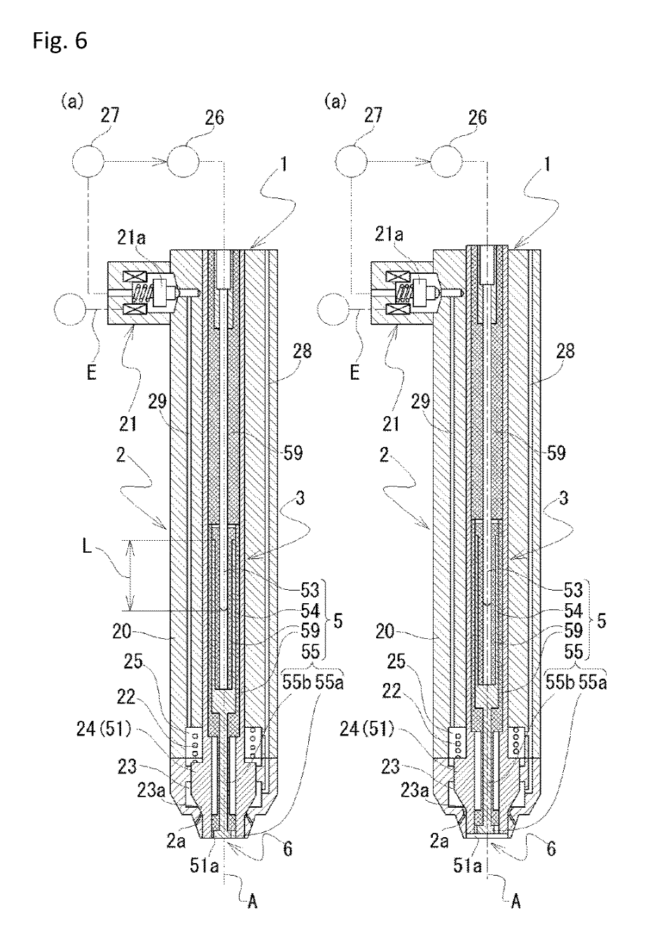

The second embodiment is an injector 1 having a built-in ignition device regarding the present invention. With regard to the injector 1 having the built-in ignition device, as illustrated in FIG. 6, a valve body of the nozzle needle 24 is integrally formed on the outer surface of an outer circumference part of the plasma generator 3 used as the ignition device. Other configuration except for that the shape of the outer surface of the outer circumference part of the plasma generator 3 is different from the first embodiment, is similar as the first embodiment, and explanation is omitted.

The injector 1 having the built-in ignition device is formed as a hollow cylindrical shape in the first embodiment, and it is configured such that the valve body for opening and closing the orifis 23a of the nozzle needle 24 is provided so as to be slidably fitted with the outer surface of the cylindrical member which constitutes the outer circumference part of the plasma generator 3. In the second embodiment, it is configured such that the valve body is integrally formed on the outer surface of the outer circumference part of the plasma generator 3. Thereby, leakage of the high pressure fuel inside can surely be prevented.

In the present embodiment, the valve body is to be formed at the tip end side of the case 51 (in the vicinity of the discharge electrode 55a) which includes the central electrode 55 of the output part being at the tip end side of the plasma generator 3, the insulator 59c which covers the central electrode 55 and the electrode 54 of the combining part, and the insulator 59a which covers the central electrode 53 being the input part and the input terminal 52 connected to the electromagnetic wave oscillator.

The fuel injecting process is similar with the first embodiment, and the high pressure fuel is introduced from the fuel supply flow path 28 into the pressure chamber 25 and the fuel sump room chamber 23 connected to the orifis 23a formed in the main body part 20. In a state where the fuel is not injected (referring to FIG. 6(a)), a pressure-receiving surface of a nozzle needle 21 on which the pressure from the high pressure fuel acts is larger in the pressure chamber 25 than the fuel sump room chamber 23, and the nozzle needle 21 is biased to the side of orifis 23a via biasing means 22. Therefore, the fuel never flows into an injection port 2a via the orifis 23a from the fuel sump room chamber 23. The actuator 21 is operated based on injection instructions (for example, current E for driving the fuel injecting valve supplied to the electromagnetic coil actuator) from the control means (for example, ECU), a valve 21a for maintaining airtightness in the pressure chamber 25 is pulled up, the high pressure fuel inside the pressure chamber 25 is released to a tank 27 via an operated flow path 29, and the nozzle needle 24 is separated from the orifis 23a by reducing the pressure in the pressure chamber 25 (referring to the FIG. 6(b)). Thereby, the high pressure fuel (gasoline, diesel fuel, gas fuel and etc.) in the fuel sump room chamber 23 passes through the orifis 23a, and is injected from the fuel injecting port 2a. When the fuel is injected, the plasma generator 3 is entirely moved upwards, as the valve body of the nozzle needle 24 is separated from the orifis 23a.

Moreover, in the present embodiment, an electromagnetic wave irradiation antenna which is a modification example of the first embodiment can also be added.

Effect of Second Embodiment

With regard to the injector 1 having the built-in ignition device of the present second embodiment, as well as the first embodiment, the plasma generator 3 having a small diameter in which the electromagnetic wave can be boosted and discharge can be performed is used as the ignition device, and therefore, malfunction or damage of the actuator 21 caused of the influence of high voltage from the ignition coil can be prevented. Since the plasma generator 3 which is positioned inside the fuel injecting device 2 has a small diameter, the outer diameter length of the device as a whole can significantly be reduced.

Moreover, leakage of the high pressure fuel inside can surely be prevented compared to the case where the nozzle needle 24 having the hollow cylindrical shape which is slidably fitted with the outer surface of the cylindrical member that constitutes the outer circumferential part of the plasma generator 3.

### INDUSTRIAL APPLICABILITY

As explained as above, the injector having the built-in ignition device of the present invention, uses as the ignition device, the small-diameter plasma generator for being able to boost the electromagnetic wave and discharge. Therefore, the malfunction or damage of the actuator caused of the influence of the high voltage is suppressed. Even though a configuration in which the axial centers of the fuel injecting device and the ignition device coincide with, the outer diameter of the device can entirely be reduced. Therefore, arranging position of the injector having the built-in ignition device can freely be selected, and the injector having the built-in ignition device can be used for various internal combustion engines. Moreover, the injector having the built-in ignition device can be used for internal combustion engine based on gasoline engine, diesel engine which uses as fuel, natural gas, coal mine gas, shale gas and etc, specifically the injector can be used for engine based on diesel engine which uses gas (CNG gas or LPG gas) as fuel from the viewpoint of the improvement of fuel consumption and environment.

### NUMERAL EXPLANATION

1 Injector Having Built-in Ignition Device
2 Fuel Injecting Device
20 Main Body Part
2a Injecting Port
22 Biasing Means
23 Fuel Sump Room Chamber
24 Nozzle Needle
25 Pressure Chamber
3 Plasma Generator
4 Electromagnetic Wave Irradiation Antenna
5 Boosting Means
51 Case
51a Tip End Part
52 Input Terminal
53 Central Electrode of Input Part
54 Electrode of Combining Part
55 Central Electrode of Output Part
55a Discharge Electrode
59 Insulator
6 Discharger

1. An injector having a built-in ignition device comprising:
an ignition device comprising: a booster having a resonation structure capacity-coupled with an electromagnetic wave oscillator configured to oscillate an electromagnetic wave; a ground electrode; and a discharge electrode, which are integrally provided to constitute a plasma generator configured to enhance a potential difference between the ground electrode and the discharge electrode by the booster, thereby generating a discharge;
a fuel injecting device comprising a valve seat and a nozzle needle having a valve body and configured to move the valve body of the nozzle needle toward or away from the valve seat to control a fuel injection, and
wherein the ignition device has a cylindrical member that constitutes an outer circumferential part of the ignition device, and the nozzle needle has a hollow cylindrical shape which is slidably fitted with an outer surface of the cylindrical member of the ignition device.

2. An injector having a built-in ignition device comprising:
an ignition device comprising: a booster having a resonation structure capacity-coupled with an electromagnetic wave oscillator configured to oscillate an electromagnetic wave; a ground electrode; and a discharge electrode, which are integrally provided to configure a plasma generator which can enhance a potential difference between the ground electrode and the discharge electrode by the booster, thereby generating a discharge;
a fuel injecting device comprising a valve seat and a nozzle needle having a valve body and configured to move the valve body of the nozzle needle toward or away from the valve seat to control a fuel injection, and
wherein the valve body of the nozzle needle is integrally formed on an outer surface of an outer circumferential part of the ignition device.

3. The injector according to claim 1,
wherein the fuel injecting device has a plurality of injecting ports opened at a predetermined interval in a circumferential direction, and
wherein an interval between the discharge electrode and the ground electrode is adjusted so as to cause a discharge between the adjacent injecting ports.

4. The injector according to claim 3,
wherein the discharge electrode has a circumferential portion formed in a continuous convex concave shape.

5. The injector according to claim 2,
wherein the fuel injecting device has a plurality of injecting ports opened at a predetermined interval in a circumferential direction, and
wherein an interval between the discharge electrode and the ground electrode is adjusted so as to cause a discharge between the adjacent injecting ports.
